(19) United States
(12) Patent Application Publication
(10) Pub. No.: US 2024/0285113 A1
(43) Pub. Date: Aug. 29, 2024

(54) An Appliance

(71) Applicant: Breville Pty Limited, Alexandria (AU)

(72) Inventors: Lochana Subasekara WIDANAGAMAGE DON, Alexandria (AU); Con PSAROLOGOS, Alexandria (AU); Richard YALLOP, Alexandria (AU); Vinay KUMAR, Alexandria (AU); Rey Anthony CARULLO, Alexandria (AU)

(73) Assignee: Breville Pty Limited, Alexandria (AU)

(21) Appl. No.: 18/572,878

(22) PCT Filed: Jun. 29, 2022
(86) PCT No.: PCT/AU2022/050667

§ 371 Date: Dec. 21, 2023

(30) Foreign Application Priority Data
Jun. 29, 2021 (AU) 2021901975

(51) Int. Cl. A47J 27/21; A47J 27/212; G01F 23/24; H02J 7/00; H02J 50/10; H05B 1/02

(52) U.S. Cl. CPC A47J 27/2105; A47J 27/21091; A47J 27/212; G01F 23/241; H02J 7/0044; H02J 50/10; H05B 1/0269; A47J 2202/00; A47J 2203/00

(57) ABSTRACT

An appliance (100) has a vessel (120) for containing substance, the vessel (120) having an electrical energy storage component and at least one electrically powered device. The appliance (100) has a base (140) on which the vessel (120) is removably located. When the vessel (120) is located on the base (140), the base (140) is configured to charge the electrical energy storage component. The electrical storage component is configured to power the at least one electrically powered device of the vessel (120).

### FIELD

The present invention relates to an appliance. The appliance, in an embodiment of the present invention, relates to a kettle.

### BACKGROUND

Existing kettles typically have a window through which a user can determine a water level in the water vessel. These water vessels typically need to be level or resting on flat surface so that the user can properly gauge the level of water in the water vessel.

A disadvantage with these existing kettles is that they do not provide an accurate means for determining the water level when the kettle is tilted, which would typically be the case when the user is filling up the kettle under a running tap. Typically, after filing a first volume of water into the kettle, the user would often need to level the kettle and then check if the first volume is at a desired level through the window. If there is not enough water, the user would fill the kettle with more water and repeat the check again. If there is too much water, the user would tip some water out from the kettle or just operate the kettle with the extra water, thereby consuming unnecessary energy for heating the extra water. In most circumstances, that extra water would sit in the kettle for a prolonged period of time, which could result in a build-up of scale in kettle.

### SUMMARY

It is an object of preferred embodiments of the invention to address the disadvantages described above and/or to at least provide the public with a useful choice.

An aspect of the present invention provides an appliance including: a vessel for containing a substance, the vessel having an electrical energy storage component and at least one electrically powered device; and a base on which the vessel is removably located, wherein, when the vessel is located on the base, the base is configured to charge the electrical energy storage component, the electrical storage component being configured to power the at least one electrically powered device of the vessel.

The appliance in a preferred embodiment is a kettle and the vessel is a water vessel of the kettle. The water vessel preferably includes a heating element that is operable to heat the substance (e.g. water or other liquid) in the water vessel when the water vessel is located on the base. The heating element is preferably centrally located on a bottom wall portion of the water vessel.

The base may be configured to wirelessly charge the electrical energy storage component wirelessly. Preferably, the base is configured to wirelessly charge the electrical storage component by induction. In a preferred embodiment, the base has a primary inductive coil; and the vessel has a secondary inductive coil, wherein, when the vessel is located on the base, an inductive power transfer is enabled between the primary coil and the secondary coil.

The base preferably includes a base control unit that is configured to wirelessly receive information from the at least one electrically powered device of the vessel.

In other embodiments, a physical electrical connection is formed when the vessel is located on the base, and the base is configured to charge the electrical storage component via the physical electrical connection when the vessel is located on the base. A base control unit may be configured to receive the information from the at least one electrically powered device of the vessel when the physical electrical connection is formed.

The at least one electrically powered device may include a plurality of illumination devices, each of which is respectively activatable depending on an amount of substance in the vessel. The vessel may, in an embodiment, have a window through which a substance level in the vessel is visible and the at least one electrically powered device preferably includes an illumination device for illuminating the window.

Preferably, the at least one electrically powered device includes a sensor arrangement and the vessel includes a vessel control unit that is in electrical communication with the sensor arrangement. In a preferred embodiment, the vessel control unit is configured to determine an amount of substance in the vessel based on measurements from the sensor arrangement. The amount of substance may be a height of the substance in the vessel or a volume of substance in the vessel, for example. The appliance may further include a display unit that is in communication with the vessel control unit, the vessel control unit being configured to display the amount of substance in the vessel on the display unit. The display unit may be provided in the vessel and/or in the base of the appliance. The display unit may, for example, include a plurality of illumination devices, each illumination device being associated with a corresponding threshold value and being selectively activatable when the amount of substance in the vessel reaches the corresponding threshold value.

The sensor arrangement preferably includes a level sensor arrangement for measuring a level of substance in the vessel. In an embodiment, the level sensor arrangement includes a plurality of low voltage probes distributed along a height of the vessel, each probe being configured to provide an output signal when immersed in substance. The plurality of probes is preferably aligned on a wall portion on which a spout of the vessel is located. Alternatively, the plurality of probes may be aligned a wall portion of the vessel that is opposite to a wall portion on which a spout of the vessel is located.

The sensor arrangement may be configured to measure a tilt of the vessel. Preferably, the sensor arrangement includes a tilt sensor for measuring a tilt of the vessel with respect to a reference plane. The tilt sensor is preferably positioned on a handle portion of the vessel. The tilt sensor may, in other examples, be positioned on a body of the vessel, or anywhere else on or in the vessel.

Another aspect of the present invention provides an appliance including: a vessel for containing a substance, the vessel including a sensor arrangement for measuring a tilt of the vessel with respect to a reference plane: a control unit that is in electrical communication with the sensor arrangement, the control unit being configured to determine an amount of substance in the vessel based on measurements from the sensor arrangement when the vessel is tilted; and a display unit that is in communication with the control unit, the control unit being configured to display the amount of substance in the vessel on the display unit.

The sensor arrangement preferably includes a tilt sensor for measuring a tilt angle of the water vessel with respect to the reference plane. The tilt sensor may, in one example, be positioned on a handle portion of the vessel.

The appliance may include a base on which the vessel is removably located, the vessel having a heating element that is operable to heat substance in the vessel when the vessel is located on the base.

The display unit may be provided in the vessel and/or in the base. The display unit may, for example, include a plurality of illumination devices, each illumination device being associated with a corresponding threshold value and being selectively activatable when the amount of substance in the vessel reaches the corresponding threshold value.

The appliance preferably further includes a level sensor arrangement for measuring a level of substance in the vessel. In an embodiment, the level sensor arrangement includes a plurality of low voltage probes distributed along a height of the vessel, each probe being configured to provide an output signal when immersed in substance. The plurality of probes is preferably aligned on a wall portion that is opposite to a wall portion of the vessel on which a spout of the vessel is located. Alternatively, the plurality of probes may be aligned with a spout of the vessel.

The control unit may be configured to determine if there is contamination in the vessel based on an output signal from the level sensor arrangement. In preferred embodiments, the control unit is configured to determine when the sensor arrangement is contaminated. For example, the control unit is configured that there is contamination if the output signal from the level sensor arrangement exceeds a threshold value. The threshold value may be defined with respect to a reading from the level sensor arrangement when there is no contamination in the vessel.

The vessel contains a heating element for heating substance in the vessel, the heating element being operable by the control unit depending on the amount of substance in the vessel. The heating element is preferably centrally located on a bottom wall portion of the vessel.

A further aspect of the present invention provides an appliance including: a vessel for containing substance to be heated, the vessel having: a sensor arrangement for measuring an amount of substance in the vessel, and a heating element for heating the substance in the vessel, the heating element being operable to provide an adjustable amount of heating based on the amount of substance in the vessel.

The vessel may include a temperature sensor mounted to a side wall portion of the vessel. Preferably, the heating element is operable to heat the substance in the vessel based on feedback from the temperature sensor.

The water vessel preferably includes a feedback actuator that provides a feedback signal depending on a substance level in the vessel, the feedback actuator being powered by the electrical energy storage component. The feedback actuator is configured to provide at least one of an audio output, a tactile output, and a visual output.

Yet a further aspect of the present invention provides an appliance control unit for determining an amount of substance in an appliance when the appliance is tilted, the appliance including a vessel for containing a substance and a sensor arrangement with a plurality of sensors distributed along a height of the vessel, the control unit being configured to: determine an upper amount of substance in the vessel in an upper region, the upper region being a region in which a width dimension of the substance volume in the upper region at different height levels of the substance level in the upper region is less than a width of the vessel at those corresponding height levels; and determine a lower amount of substance in the vessel in a lower region, the lower region being a region in which the width dimension of the substance volume in the lower region at different height levels in the lower region is equal to a width of the vessel at those corresponding height levels, wherein the amount of substance in the vessel is a summation of the upper amount of substance and the lower amount of substance.

The sensor arrangement includes a tilt sensor for measuring a tilt angle of the appliance with respect to a reference plane, the control unit being configured to determine the second height of the substance based on the tilt angle.

### BRIEF DESCRIPTION OF THE DRAWINGS

Preferred embodiments of the invention will now be described, by way of non-limiting example, with reference to the accompanying drawings in which:

FIG. 1 shows a kettle according to an embodiment of the present invention;

FIG. 2 shows a system diagram of the kettle of FIG. 1:

FIG. 3 shows the kettle shown in FIG. 1 in a tilted configuration; and

FIG. 4 shows a model for volume computation with respect to the kettle shown in FIG. 3.

### DESCRIPTION OF EMBODIMENTS

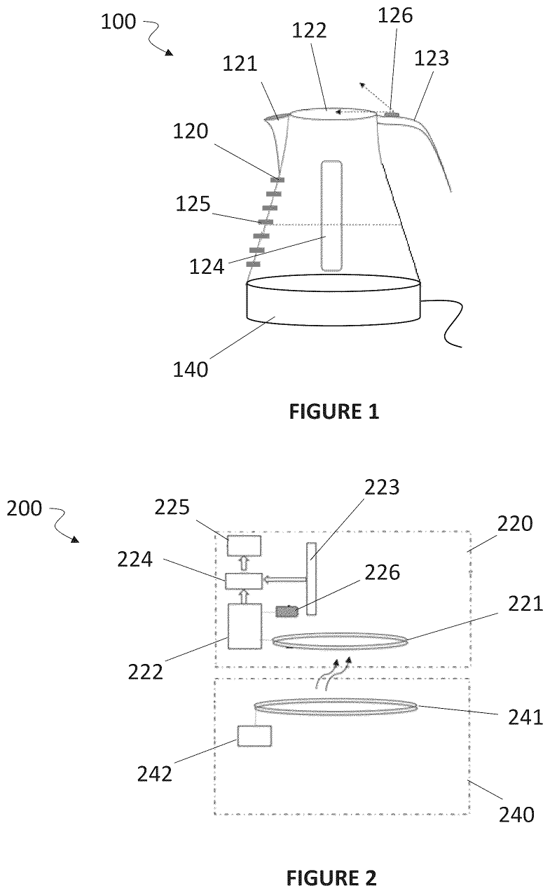

With reference to FIG. 1, the kettle 100 includes a water vessel 120 for containing water (or any other liquid) to be heated and a base 140 on which the water vessel is removably located. The water vessel 120 contains a heating element for heating the water contained therein. The heating element is operable to heat the water only when the water vessel 120 is located on the base 140. In preferred embodiments, the heating element is operable to boil the water contained in the water vessel. The kettle 100 is an example appliance according to a preferred embodiment of the present invention. The vessel, in other examples, may be a vessel of any other appliance such as, but not limited to, a coffee carafe, a juicer, a blender, or a mixing bowl; the vessel in these other examples being for containing a substance which may be a solid, liquid or other fluid.

The base 140 is a platform on which the water vessel 120 can be stably located. The base 140 is connected to a mains power supply via an electrical cable. The base 140 has a shape that corresponds to a shape of a flat bottom wall portion of the water vessel 120 so as to provide stability to the water vessel 120 when the water vessel 120 is located thereon. The top surface of the base 140 is substantially flat so as to maximise a surface contact area with the flat bottom wall portion of the water vessel 120. The base 140 may include one or more first contact portions each being contactable by a respective second contact portion of the water vessel to provide stability to the water vessel when located on the base. By way of example, the base 140 may include one or more recesses each for complementarily receiving a respective protrusion in an underside of the water vessel to provide stability to the water vessel when located on the base. The base 140 includes a base control unit and an induction coil for inductive power transfer with an induction coil in the water vessel 120. The base control unit and the induction coil will be described in further detail below. In other examples, the base may include an electrical-engaging portion that is engageable with an electrical-engaging portion in an underside of the water vessel to form a physical electrical connection. In these other examples, the electrical-engaging portion in the base may be an upstanding contact portion (e.g. a 3-pole connector or a 5-pole connector) that is engageable with an corresponding electrical port in the underside of the water vessel to form the physical electrical connection. Further, in these other examples, the physical electrical connection facilitates a flow of electricity from the base to the water vessel and facilitates a two-way exchange of data between a control unit of the water vessel and a control unit of the base.

In some embodiments of the invention, the base 140 includes an electronic display unit for displaying an amount of water in the water vessel. The display unit may also be configured to display a temperature of water in the water vessel, a timer, and if there is any contamination (e.g. scale build up) in the water vessel. In other embodiments, an electronic display unit is, instead or also, provided in the water vessel.

The water vessel 120 is a jug or container for containing water to be heated. In this embodiment, the water vessel 120 has a substantially frustoconical shape. In other embodiments, the water vessel may have any another volumetric shape. For example, in other embodiments, the water vessel may be cylindrical. The water vessel 120 has a body having a bottom wall (or floor) portion and side wall portion(s) that extend from the bottom wall portion to define an enclosed volume in which water can be contained. The shape of the bottom wall portion corresponds generally to the shape of the base 140 on which the water vessel 120 is located.

The water vessel has a spout 121 from which water in the water vessel can be dispensed, a lid 122, and a handle 123. The spout 121 is located in an upper region, or top, of the water vessel body. The lid 122 can be adjusted or removed to reveal an opening in the water vessel 120 through which water can be provided into the water vessel 120. The spout 121 and the handle 123 are located on opposite sides of the water vessel 120.

The water vessel 120 has a window 124 on a side wall portion thereof through a level of which water contained in the water vessel can be viewed. The window 124 preferably spans a substantial height of the water vessel 120. The window 124 is provided on a sidewall portion of the water vessel 120, between the spout 121 and the handle 123. In other embodiments, the window 124 may be provided on a wall portion of the water vessel from which the handle extends. In other embodiments, the water vessel may not include a window.

As previously described, the water vessel 120 has a heating element that is activatable to heat the water in the water vessel only when the water vessel is centrally located on the base 140. The heating element is centrally located on the bottom wall portion of the water vessel 120 in the enclosed volume defined by the water vessel 120. The heating element is activated through a physical electrical connected between the base 140 and the water vessel 120, the physical connection therebetween being formed when the water vessel 120 is located on the base 140. In particular, the base 140 has an electrical-engaging portion that is engageable with an electrical-engaging portion in an underside of the water vessel 120 to form a physical electrical connection through which electricity from the base 140 can be provided to the water vessel 120 to activate the heating element. In these other examples, the electrical-engaging portion in the base may be an upstanding contact portion (e.g. a 3-pole connector or a 5-pole connector) that is engageable with a corresponding electrical port in the underside of the water vessel. The heating element, in other examples of the present invention, may be activated wirelessly by the base. The heating operation of the heating element is controlled by a proportional-integral-derivative (PID) controller.

The water vessel 120 further contains an electrical energy storage component that is charged when the water vessel is located on the base and a plurality of electrically powered devices that are powered by the electrical energy storage component. The electrical energy storage component may be a capacitor (e.g. a supercapacitor) or a battery. By having the electrical energy storage device in the water vessel 120, the electrically powered devices can be powered and is operable when the water vessel 120 is removed from the base 140. These electrically powered devices may also be powered and operable when the water vessel 120 is on the base 140.

The plurality of electrically powered devices that are powered by the electrical energy storage component includes an electronic display unit, a sensor arrangement, one or more illumination devices, a feedback actuator, and one or more temperature sensors. These devices will be described in further detail below.

The electronic display unit of the water vessel 120 is for displaying an amount of water in the water vessel 120. The display unit may also be configured to display a temperature of water in the water vessel 120, a timer, and if there are contaminants (e.g. scale build up) in the water vessel 120. The display unit is provided on the handle portion or on a body portion of the water vessel 120. In other examples, an electronic display unit is, instead or also, provided in the base 140. The electronic display unit may be additionally configured to display a timer indicating an estimated time for the water in the water vessel 120 to reach the desired temperature during a heating operation. The timer displayed on the display unit could be a countdown timer, for example. In particular, a control unit of the water vessel 120 is configured to determine the time for the water in the water vessel 120 to reach the desired temperature based on the volume of water contained in the water vessel 120.

The sensor arrangement of the water vessel 120 is used to determine an amount of water contained in the water vessel 120 regardless of an angle at which the water vessel is held, i.e. regardless of whether the water vessel 120 is tilted or not. Typically, when a user fills up the water vessel under a running tap, the water vessel 120 would be tilted or angled downwardly towards the tap. Simply having a level sensor for measuring a level of water in the water vessel 120 by itself on one side of the water vessel 120 would not be sufficient to determine an amount of water in the water vessel 120 because the level of water would vary depending on the angle at which the water vessel 120 is held. To that end, the sensor arrangement according to preferred embodiments of the present invention is further configured to measure a tilt of the water vessel 120 with respect to a reference plane such that the amount of water in the water vessel 120 can be accurately determined regardless of the angle at which the water vessel 120 is held. The reference plane is preferably a horizontal plane. In other example, the reference plane may be a vertical plane. In yet other examples, the reference plane is a combination of horizontal and vertical planes. The amount of water that in the water vessel 120 is communicated to the user in real-time while the user is filling up the water vessel 120. Thereby, the user is provided with the ability to accurately control the amount of water to be heated by the kettle 100.

In preferred embodiments as shown in FIGS. 1 and 2, the sensor arrangement includes a level sensor arrangement 125 (or a level sensor array) for measuring a level of water in the water vessel and a tilt sensor 126 for measuring a tilt of the water vessel 120. In other embodiments, the sensor arrangement may include a first level sensor arrangement for measuring a level of water in the water vessel 120 at a first wall portion of the water vessel 120 and a second level sensor arrangement for measuring a level of water in the water vessel 120 at a second wall portion of the water vessel, opposite to the first wall portion. In these other embodiments, the readings of the first and second sensor arrangements can be used to determine if the water vessel 120 is tilted and the angle at which the water vessel is tilted. In yet further other embodiments, the sensor arrangement may include a plurality of level sensor arrangements, each level sensor arrangement being provided on a respective wall portion of the water vessel 120. For these other embodiments, a separate tilt sensor would not be required.

The level sensor arrangement 125 is for measuring a level of water in the water vessel 120. The level sensor arrangement 125 includes a plurality of low voltage probes distributed along a height of the water vessel 120, each probe being configured to provide an output signal when immersed in water. The plurality of probes is aligned on a wall portion directly below the spout of the water vessel 120. In particular, the probes are aligned with the spout of the water vessel 120. In other embodiments, the probes may be provided on a wall portion that is opposite to a wall portion on which the spout 121 is located. The vertical spacing between the probes may be between about 1 mm and about 20 mm. The vertical spacing between the probes would vary depending on the shape of the vessel 120 and the desired measurement accuracy (more sensors being provided for higher accuracy). In a preferred example, each probe includes two exposed electrical portions in series with a resistor forming an open circuit. The exposed electrical portions are separate from each other to create a break in the circuit. When water covers the exposed portions, exposed electrical portions become electrically connected thereby closing the circuit and causing an electrical current to flow, resulting in a detectable voltage across the resistor or a detectable voltage across the exposed portions. The detectable voltage is measured to determine when water is present at that corresponding level. In particular, the detectable voltage is compared to a threshold value to determine if water is present at that corresponding level. In other examples, the level sensor arrangement may use other electronic sensors for level detection. For example, the level sensor arrangement may include a capacitive sensor.

The measured voltage can also be used to determine if the exposed electrical portions of the respective probe are contaminated. In particular, contamination on the exposed portions of the probe (e.g. any built up scale on the exposed portions) would create a resistance at the exposed portions. When the voltage value is measured with respect to electrical portions that are not contaminated, the measured voltage would be a normal voltage value. The exposed portions can be determined to be contaminated when the measured voltage with respect to those electrical portions is not substantially equal to the normal voltage value. If the difference between the measured voltage value and the normal voltage value exceeds a predetermined threshold, a control unit is configured to warn or prompt a user to clean the water vessel. The warning or prompt can be displayed on at least one of the electronic display unit, the feedback actuator, and the illumination device(s).

The tilt sensor 126 is for measuring a tilt of the water vessel 120 with respect to a reference plane. The tilt sensor 126 is positioned on a handle portion 123 of the water vessel. In other embodiments, the tilt sensor 126 may be provided on any other wall portion of the water vessel 120. The tilt sensor 126 provides a tilt angle of the water vessel 120 with respect to the reference plane. The tilt angle sensor 126 is, in a preferred embodiment, pre-programmed with a reference horizontal x-axis and a reference y-axis and is configured to sense when the tilt sensor 126 is displaced or offset from one or both of the reference horizontal x-axis and the reference y-axis.

The electrical energy storage component is for powering the electrically powered devices of the water vessel 120. The electrical energy storage component may be a capacitor (e.g. a supercapacitor) or a battery for example. The electrical energy storage component is charged when the water vessel 120 is located on the base 140.

The electrical energy storage component is wirelessly charged by the base 140. In preferred embodiments of the present invention, the water vessel 120 includes an induction coil that can be inductively coupled with an induction coil in the base 140 to facilitate an inductive power transfer therebetween. As used herein, the induction coil in the base is a ‘primary’ (or first) induction coil while the induction coil in the water vessel is a ‘secondary’ (or second) induction coil. Thereby, when the water vessel 120 is located on the base 140, the primary inductive power coil in the base 120 can supply power from the mains power supply to the secondary inductive coil in the water vessel 120. The electrical energy storage component is in electrical communication with the secondary induction coil of the water vessel and stores energy that is received by the secondary induction coil from the primary induction coil.

The inductive coupling between the primary induction coil and the secondary induction coil facilitates a two-way transfer of electrical energy. On one hand, the secondary induction coil is configured to receive energy from mains power supply for storage in the electrical energy storage component via the primary induction coil. On the other hand, the primary induction coil is configured to receive information, in the form of electrical energy, from the at least one electrically powered device of the water vessel via the secondary induction coil.

The or each illumination device of the water vessel 120 is selectively activatable depending on an amount of water in the water vessel 120. The illumination device(s) is/are provided near or adjacent the window of the water vessel 120 through which a water level in the vessel is visible, the illumination device(s) being activatable to illuminate the window. The illumination device(s) allow the user to clearly view the water level while filling the water vessel 120. Where a plurality of illumination devices is provided, each illumination device is associated with a corresponding threshold and is selectively activatable when the amount of water in the water vessel 120 reaches the corresponding threshold.

The feedback actuator of the water vessel 120 is configured to provide a feedback signal depending on a water level in the water vessel 120. The feedback signal in particular is a signal that is noticeable by the user. The feedback actuator is configured to provide at least one of an audio output, a tactile output, and a visual output. The feedback actuator may be configured to provide haptic feedback as the water vessel 120 is being filled with water. For example, the handle 123 may be provided with a vibration unit that is configured to, when a user is filling up the water vessel 120 with water, vibrate when one or more predetermined amounts of water in the water vessel 120 is reached. The vibration unit may, preferred embodiments, be activatable to vibrate when the water vessel 120 is tilted and/or when the water vessel 120 is removed from the base 140.

The temperature sensor(s) is/are located on the side wall portion of the water vessel 120, away from the heating element. The temperature sensor(s) provide feedback control for the heating element of the water vessel 120. Locating the temperature sensor(s) away from the heating element avoid the temperature sensor(s) from experiencing high temperature turbulence and direct heat transfer from the heating element, which would compromise the reliability of the readings from the temperature sensor(s).

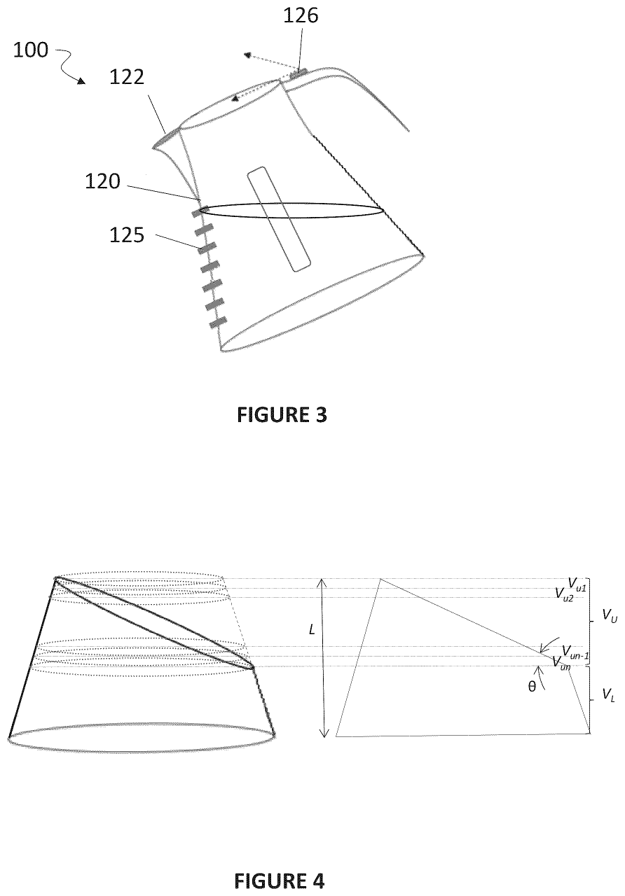

A system diagram 200 of the kettle 100 is shown in FIG. 3. The water vessel system 220 contains the secondary induction coil, while the base system 240 contains the primary induction coil, which is inductively coupled with the secondary coil when the water vessel is located on the base as previously described. The base system 240 contains a coil driver 242 for receiving electrical energy from the mains power supply for driving the primary induction coil.

The water vessel system 220 includes a water vessel control unit 224 that is in electrical communication the electrical energy storage component 222 and with the electrically powered devices of the water vessel, which include the sensor arrangement 223, the illumination device(s) 226, and the electronic display unit 225. The control unit 224 is a computer processor or a microcontroller that is configured to communicate with the electrically powered devices to activate and/or control their operation. The water vessel control unit 224 is configured to determine an amount of water (e.g. a height of volume of water) in the water vessel based on measurements from the sensor arrangement 223 and to control an operation of at least one of the electronic display unit 225, the illumination device(s) 226, and the feedback actuator based on the determined amount of water in the water vessel.

In some embodiments, the control unit 224 may have an integrated tilt sensor for that can be adapted to determine when the water vessel is tilted to determine an amount of water in the water vessel. In other embodiments, the tilt sensor is separate from the control unit.

The water vessel control unit 224 is configured to monitor the charge status or amount of electrical energy stored by the electrical energy storage component 222. The control unit 224 may, in some embodiments, be configured to display the charge status of the electrical energy storage component on the electrical display unit 225.

The water vessel control unit 224 is also configured to determine when the water vessel is located on the base and when the vessel is removed from the base. In this regard, the water vessel control unit 224 is configured to detect when an inductive coupling between the primary coil and the secondary coil is established to determine whether or not the water vessel is located on the base. If the water vessel is determined to be on the base, the control unit is configured to enable the electrical energy storage component to be charged. When the water vessel control unit 224 determines that the water vessel is located on the base, the water vessel control unit may be configured to enable the heating element of the water vessel for heating the water contained therein.

The water vessel control unit 224 is configured to determine if there is contamination in the water vessel 120 based on an output signal from the sensor arrangement. The control unit 224 is configured to receive the voltage measured across the probes of the level sensor arrangement and to compare the measured voltage value with a normal voltage value to determine a difference. If the difference between exceeds a threshold value, the control unit 224 is configured to warn or prompt a user to clean the water vessel 120. The warning or prompt can be displayed, by the control unit 224, on the electronic display unit 225 and/or on the illumination device(s) 224. Additionally or alternatively, the contamination determination may be performed by a control unit of the base system 240.

The base system 240 has a base control unit that is configured to receive information relating to the water vessel from one or more of the electrically powered devices of the water vessel 120. The base control unit is in communication with the water vessel control unit 224. The base control unit is a computer processor or a microcontroller that is configured to communicate with the electrically powered devices to activate and/or control their operation.

The base control unit is configured to determine when the water vessel 120 is located on the base and to control an amount of heating provided by the heating element depending on an amount of water contained in the water vessel 120. An amount of heating provided by the heating element can be controlled with feedback from the temperature sensor(s) of the water vessel, previously described. Based on the information of the amount of water in the water vessel 120 and with feedback from the temperature sensor(s), the water vessel control unit 224 is configured to control a heating provided by the heating element using PID (proportional-integral-derivative) control.

As previously described, the water vessel 120 of the kettle 100 includes a level sensor arrangement 125 for measuring a level of water in the water vessel. The level sensor arrangement 125 includes a plurality of low voltage probes distributed along a height of the water vessel. These probes are aligned with the spout 122, that is the probes are provided on the spout side of the water vessel 100. The water vessel 120 further includes a tilt sensor 126, located on the handle 123 of the water vessel 120, for measuring a tilt of the water vessel 120 with respect to a reference plane. The kettle 100 according to preferred embodiments provides the user with a way in which they can accurately monitor the volume of water in the kettle in real-time while the kettle is being filled with water, without having to level the kettle and then check the level of water in the kettle 100. In addition, the kettle 100 according to preferred embodiments provides the user with a timer function that indicates, in real-time, a time or duration for the water in the kettle 100 to reach a desired temperature (e.g. a boiling temperature) while, for example, the kettle 100 is being filled with water.

### Example 1

An example of a real-time volume computation that is performed by the water vessel control unit 224 will be described with reference to FIGS. 3 and 4. The water vessel 120 of the kettle 100 in this example has a substantially frustoconical shape. The water vessel 120 includes a computer memory or a database that is accessible by the water vessel control unit. The computer memory stores a look-up table that maps a plurality of level (or height) values in the water vessel to respective width value, each width value corresponding to a horizontal distance from that respective level (or height) in the water vessel to the opposite side wall portion of the water vessel when the water vessel is not tilted. The width value may be a diameter value or radius value of the water vessel at that particular level (or height).

The difference (step or spacing) between the level values in the sequence of level values stored in the look-up table affects the resolution or sensitivity of the calculated water volume value with respect to the actual water volume value and affects the volume computation/processing times. A smaller difference would provide a higher resolution or sensitivity of the calculated water volume value and a slower computation time, while a larger difference would provide a lower resolution or sensitivity of the calculated water volume value at a faster computation time. Accordingly, the spacing is chosen to optimise the resolution/sensitivity of the calculated water volume and the computation time. For the look-up table relating to the water vessel 120, there is a constant difference (or spacing) between adjacent level values in the sequence of level (or height) values stored in the look-up table. For this example, a difference between two adjacent water levels in the sequence may be any one of about 0.1 mm, 1 mm, up to about 2 mm, up to about 5 mm, or up to about 10 mm. In other examples, there may be a variable difference (or spacing) between adjacent level (or height) values stored in the look-up table. In this example, the spacing between adjacent values may be larger between adjacent values where the width values (e.g. diameters or radii) corresponding to those adjacent values are substantially the same, and may be smaller between adjacent values where the width values (e.g. diameters or radii) corresponding to those adjacent values are substantially different, in that the corresponding width values are any one of not identical, more than 1% different, more than 5% different, more than 10% different, or up to 30% different.

When the water vessel 120 is tilted, the level sensor arrangement 125 that is aligned with the spout 122 would provide a level reading L indicative of the water level at that spout side of the water vessel 120 while the tilt sensor 126 would provide an angle reading θ indicative of the tilt angle of the water vessel 100 relative to a horizontal x-axis. The water vessel control unit 224 is configured to receive the level reading L and the angle reading θ, and is configured to determine the volume V of the water contained in the water vessel. In this regard, the water vessel control unit 224 determines the volume V of water by computing a volume of water in an upper region Vu and a volume of water in a lower region V_{L}. The upper region spans a height corresponding to a vertical (upright) distance between the water level L on the spout side of the water vessel 120 and the water level on the opposite handle side of the water vessel 120. The lower region, on the other hand, spans a height corresponding to a vertical (upright) distance between a floor of the water vessel 100 and the water level on the handle side. The volume of water in the upper region Vu is determined, by the water vessel control unit, as a sum of volumes of subregions in that upper region, while the volume in the lower region V_{L} can be determined, by the water vessel control unit, as a sum of volumes of subregions in that lower region.

$$V = {V}_{U} + {V}_{L}$$

The volume of water in a subregion of the upper region is determined based on a level value of that subregion (which is a stepped value with respect to the level reading L of water at the spout side from the level sensor arrangement 125), the width value of the water vessel at that level as determined from the look-up table, and the tilt angle θ. The subregions in this example have the same heights h, i.e. the step heights between sequential subregions is constant/uniform.

For example, the 1^{st} upper subregion, which is a topmost subregion in the upper region, would have a level l₁=L−h at the spout side. The water vessel control unit 224 is configured to determine the radius r₁ of the water vessel at that level l₁ from the look-up table as previously described. The look-up table in this example could contain at least about 400 samples, preferably between 500 to 600 samples, each sample correlating a level of the water vessel to a corresponding radius. A width dimension w₁ of water volume in the 1^{st} upper subregion can be determined trigonometrically based on the height h and the tilt angle θ plus a difference between the radius r₁ at that level l₁ and the radius r₀ at the level reading L from the level sensor arrangement. The difference accounts for any changes in cross-section from the previous level to the current level. Once the width dimension w₁ of water volume in the 1^{st} upper subregion is known, the area of water in the water vessel at that subregion A₁ can be determined. For simplification purposes, the volume of water within the 1^{st} upper subregion is approximated to a cylindrical volume such that the volume of water within that subregion can be determined as a product of the determined area of water in the first subregion A₁ and the height of the subregion h.

The 2^{nd} upper subregion, which is immediately below the 1^{st} subregion in the upper region, would have a level l₂=L−2 h at the spout side. The water vessel control unit 224 is configured to determine the radius r₂ of the water vessel at that level l₂ from the look-up table as previously described. A width dimension of the 2nd subregion w₂ can be determined trigonometrically based on the height 2×h and the tilt angle θ plus a difference between the radius r₂ at that level l₂ and the radius r₀ at the level reading L from the level sensor arrangement. The difference accounts for any changes in cross-section from the previous level to the current level. Alternatively, the width dimension can be determined based on the width dimension of the immediately previous subregion plus a trigonometric equation based on the height h and the tilt angle θ plus a difference between the radius r₂ at that level l₂ and the radius r₀ at the level reading L from the level sensor arrangement. Once the width dimension w₂ of water volume in the 2^{nd} upper subregion is known, the area of water in the water vessel at that subregion A₂ can be determined. Again, for simplification purposes, the volume of water within the 2nd upper subregion is approximated to a cylindrical volume such that the volume of water within that subregion can be determined as a product of the determined area of water in the second subregion A₂ and the height of the subregion h.

To put generally, the n^{th} upper subregion would have a level lₙ=L−nh at the spout side. The water vessel control unit 224 is configured to determine the radius rₙ of the water vessel at that level lₙ from the look-up table as previously described. A width dimension of water volume in the n^{th} subregion wₙ can be determined trigonometrically based on the height n×h and the tilt angle θ plus a difference between the radius rₙ at that level lₙ and the radius r₀ at the level reading L from the level sensor arrangement. The difference accounts for any changes in cross-section from the previous level to the current level. Alternatively, the width dimension can be determined based on the width dimension of the immediately previous subregion plus a trigonometric equation based on the height h and the tilt angle (plus a difference between the radius rₙ at that level lₙ and the radius r₀ at the level reading L from the level sensor arrangement. Once the width dimension wₙ of water volume in the n^{th} subregion is known, the area of water in the water vessel at that subregion Aₙ can be determined. Again, for simplification purposes, the volume of water within the n^{th} subregion is approximated to a cylindrical volume such that the volume of water within that subregion can be determined as a product of the determined area of water in the second subregion Aₙ and the height of the subregion h.

In another example, a calculated width dimension of a subregion is stored in memory for the calculation of a width dimension of a subsequent subregion. The calculated width dimension of a subregion is used for are and volume calculations for that subregion as previously described. In particular, the width dimension of the 1st subregion w₁ can be determined trigonometrically based on the height h and the tilt angle θ plus a difference between the radius r₁ at that level l₁ and the radius r₀ at the level reading L from the level sensor arrangement (w₁=(h×cot (θ))+(r₁−r₀)). The width dimension of the 2nd subregion w₁ can be determined trigonometrically based on the height h and the tilt angle θ plus a difference between the radius r₂ at that level l₂ and the radius r₁ at the immediately previous level l₁ plus the width dimension of the 1st subregion (w₂=(h×cot (θ)+(r₂−r₁)+w₁). The width dimension of the n^{th} subregion can be determined trigonometrically based on the height h and the tilt angle θ plus a difference between the radius rₙ at that level lₙ and the radius rₙ₋₁ at the immediately previous level lₙ₋₁ plus the width dimension of the previous n−1th subregion (wₙ=(h×cot (θ)+(rₙ−rₙ₋₁)+wₙ₋₁).

The volumes of the upper subregions are computed until the water vessel control unit 224 determines that the calculated width dimension of the water volume in a subregion is equal to the diameter of the water vessel at that subregion level based on the look-up table (wₘ=2×rₘ). Once the water vessel control unit 224 determines this condition is met, the volume computations for all of the previous upper subregions including this subregion (the 1^{st} to m^{th} subregions) in the upper region is finalized.

The volume of the upper region can be determined based on the following formula:

V_{U}=Σₙ₌₁^{m}Vᵤₙ

where

Vᵤₙ=h×Aₙ

Aₙ=rₙ²×arcos(rₙ−wₙ)/rₙ)−(rₙ−wₙ)×\sqrt{2×rₙ×wₙ−wₙ²};
h=step values between level values in the look-up table:

wₙ=(h×n×cot(θ)+rₙ−r₀;
θ=tilt angle reading from the tilt sensor;
rₙ=radius value corresponding to lₙ (determined from the look-up table)
r₀=radius value corresponding to L (determined from the look-up table)

lₙ=L−(h×n);
L=water level value at the spout side from the level sensor;
n=integer representing the subregion number in the upper region with n=1 being the topmost subregion; and
m=last subregion in the upper subregion that satisfies the condition wₘ=2 rₘ.

From the upper region volume computation, the last m^{th} upper subregion in which the calculated width dimension of the water volume in a subregion is equal to the diameter of the water vessel, can be determined. The height value of the lower region corresponds to the level value of the last m^{th} upper subregion. The width value (radius) of the water vessel at that level value can be determined form the look-up table as previously described. Subsequently, the volume of water in the lower region can be determined.

The volume of water in a subregion of the lower region is determined based on a level value of that subregion (which is a stepped value with respect to the level reading lₘ of the last m^{th} upper subregion of the upper region) and the width value of the water vessel at that level as determined from the look-up table. The subregions in this example have the same heights h, i.e. the step heights between sequential subregions is constant/uniform.

For example, the 1^{st} lower subregion, which is a topmost subregion in the lower region, would have a level l₁=Iₘ−h at the spout side. The water vessel control unit 224 is configured to determine, from the look-up table previously described, the radius r₁ of the water vessel at that level l₁ and a radius r₀ at a level l₀ immediately above that level to account for any changes in cross-section from the previous level to the current level. The volume of water within the 1^{st} lower subregion, which is approximated to a cylindrical volume for simplification purposes, can subsequently be determined based on an average of the radius values and the height of the subregion h.

The 2^{nd} lower subregion, which is immediately below the first subregion in the lower region, would have a level l₂=lₘ−2 h at the spout side. The water vessel control unit 224 is configured to determine, from the look-up table previously described, the radius r₂ of the water vessel at that level l₂ and a radius r₁ at a level l₁ immediately above that level to account for any changes in cross-section from the previous level to the current level. The volume of water within the 2nd lower subregion, which is approximated to a cylindrical volume for simplification purposes, can subsequently be determined based on an average of the radius values and the height of the subregion h.

To put generally, the kth lower subregion would have a level lₖ=lₘ−kh at the spout side. The water vessel control unit is configured to determine, from the look-up table previously described, the radius rₖ of the water vessel at that level lₖ and a radius rₖ₋₁ at a level lₖ₋₁ immediately above that level to account for any changes in cross-section from the previous level to the current level. The volume of water within the kth lower subregion, which is approximated to a cylindrical volume for simplification purposes, can subsequently be determined based on an average of the radius values and the height of the subregion h.

The volumes of the lower subregions are computed until the water vessel control unit 224 reaches the last level in the look-up table (wₚ). Once the water vessel control unit 224 determines this condition is met, the volume computations for all of the previous lower subregions including this subregion (the m+1^{th} to p^{th} subregions) in the lower region is finalized.

The volume of the upper region can be determined based on the following formula:

$${V}_{L} = {\sum }_{k = 1}^{p} {V}_{l k}$$

$$where$$

$${V}_{l k} = π \times {( \frac{{r}_{k} + {r}_{k - 1}}{2} )}^{2} \times h$$

h=step values between level values in the look-up table;
rₖ=radius value corresponding to lₖ (determined from the look-up table) lₖ=lₘ−(h×k);
lₘ=last level value of the upper region, wherein lₘ=l₀;
k=integer representing the subregion number in the lower region with k=1 being the topmost subregion in the lower region (immediately below the upper region);
m=last subregion in the upper subregion that satisfies the condition wₘ=2 rₘ;
p=last value in the look-up table corresponding to a floor of the water vessel.

Alternatively, in an example where the water vessel has a substantially conical shape, the following volumetric formula for a frustocone could be used to determine the volume of water in the lower region.

$${V}_{L} = \frac{1}{3} \times π \times {h}_{L} \times ( {r}_{L}^{2} + {r}_{0}^{2} + ( {r}_{L} \times {r}_{0} ) )$$

where
   h_{L}=lₘ+1
r_{L}=radius value corresponding to lₘ₊₁ (determined from the look-up table);
r₀=the radius of floor of the water vessel

### Example 2

Another volume computation example will be described. In this example, the water vessel includes a computer memory or a database that is accessible by the water vessel control unit. The computer memory stores a look-up table that maps level sensor measurements and measurements from the tilt sensor to corresponding volume values, which are predetermined. An example look-up table is shown below. In operation, the water vessel control unit 224 would determine the volume of water from the look-up based on the tilt angle θ from the tilt sensor and the water level measurement L at the spout side from the level sensor arrangement. The table is completed and programmed into or stored in the computer memory of the water vessel. In this example, the look up table may store the volume of water in litre units or in cup units. The water vessel in some embodiments may allow the user to switch the units for the volume displayed on the electronic display unit.

| | θ (°) | | | | |
|---|---|---|---|---|---|
| L (mm) | 0 | 1° | . . . | a − 1° | a° |
| 500 mm | . . . | . . . | . . . | . . . | . . . |
| 475 mm | . . . | . . . | . . . | . . . | . . . |
| . | . | . | . | . | . |
| . | . | . | . | . | . |
| . | . | . | . | . | . |
| 50 mm | . . . | . . . | . . . | . . . | . . . |
| 25 mm | . . . | . . . | . . . | . . . | . . . |

The steps or differences between the angle values and/or level values can be adjusted. The angle values in the look-up table may be with respect to a horizontal axis or with respect to a vertical axis. In another example, the look-up table may be a 3-dimensional look-up table in which the level measurements are mapped to a tilt angle with respect to a horizontal axis and a tilt angle with respect to a vertical axis.

### Example 3

Another volume computation example will be described. In this example, similar to Example 1, the water vessel includes a computer memory or a database that is accessible by the water vessel control unit 224. The computer memory stores a look-up table that maps a plurality of level (or height) values in the water vessel to respective width value, each width value corresponding to a horizontal distance from that respective level (or height) in the water vessel to the opposite side wall portion of the water vessel when the water vessel is not tilted. The width value may be a diameter value or radius value of the water vessel at that particular level (or height).

The water vessel control unit is configured to compute the volume of water in the water vessel based on the level sensor measurement L and angle measurement θ from the tilt sensor. The formula used for the volume computation for the water vessel shown in FIG. 3, which is substantially frustoconical, is:

$$V = \frac{π {R}^{3} H}{3} - \frac{π k}{3} {( \frac{h}{\sqrt{{k}^{2} - {m}^{2}}} )}^{3}$$

where
   R=the radius of the floor of the water vessel;
   H=the height from a floor of the water vessel an imaginary peak of the frustocone;

$$k = \frac{H}{R}$$

h=r×(k−m)
r=radius value corresponding to h (determined from the look-up table);
m=tan θ

### Example 4

An example of a timer function for computing, by the water vessel control unit, the time or duration for the water in the water vessel to reach a desired temperature (e.g. a boiling temperature) will be described. Once the volume of water contained in the water vessel is known (e.g. using any one of the previously described examples), the time t needed for the water to reach the desired temperature T_{f} can be determined, by the water vessel control unit, based on the specific heat capacity formula:

Q=mcΔT
where energy Q=Power P×time t, so

Pt=mcΔT
which can be rearranged as:

$$t = \frac{m c Δ T}{P}$$

where
   m is the mass which, for water, would be equal to the volume V
   c is the specific heat capacity which, for water at room temperature, would be 4,184 J·kg⁻¹·K⁻¹;
   ΔT=|T_{f}−T₀|, T_{f} being the final (desired) temperature and T₀ being the starting temperature; and
   P is the heating power providing by the heating element to heat the water.

The power of the heating element can be determined by the control unit by measuring the voltage, current, and frequency signal used to drive the heating element. Alternatively, the power value can be preset into the control unit.

For water at room temperature (of about 25° C.) that is desired to reach boiling temperature (100° C.), the above equation can be simplified to:

$$t = \frac{130.75 \times V}{P}$$

Therefore, heating 1 L (1 kg) of water, where the heating power from the heating element is 2,400 W, would take 130.75 seconds (i.e. about 2.18 minutes). The above formula is programmed into the water vessel control unit 224 such that the water vessel control unit 224 is configured to provide a real-time display, on the electronic display unit, of the time for water to reach the desired boiling temperature. Thereby, as the user fills up the kettle, the user is provided with an indication of time needed for the water to reach the desired boiling temperature.

The temperature sensor in the water vessel is used to determine the starting temperature of the water in the water vessel.

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

1. An appliance including:
a vessel for containing substance, the vessel having an electrical energy storage component and at least one electrically powered device; and
a base on which the vessel is removably located,
wherein, when the vessel is located on the base, the base is configured to charge the electrical energy storage component, the electrical storage component being configured to power the at least one electrically powered device of the vessel.

2. The appliance of claim 1, wherein the base is configured to wirelessly charge the electrical energy storage component.

3. The appliance of claim 1, wherein the base includes a base control unit that is configured to wirelessly receive information from the at least one electrically powered device of the vessel.

4. The appliance of claim 1, wherein:
the base has a primary inductive coil; and
the vessel has a secondary inductive coil,
wherein, when the vessel is located on the base, an inductive power transfer is enabled between the primary coil and the secondary coil.

5. The appliance of claim 1, wherein the at least one electrically powered device includes one or more illumination devices that are activatable depending on an amount of substance in the vessel.

6. The appliance of claim 1, wherein the at least one electrically powered device includes a sensor arrangement, and the vessel includes a vessel control unit that is in electrical communication with the sensor arrangement, the vessel control unit being configured to determine an amount of substance in the vessel based on measurements from the sensor arrangement.

7. The appliance of claim 6, further including a display unit that is in communication with the vessel control unit, the vessel control unit being configured to display the amount of substance in the vessel on the display unit.

8. The appliance of claim 6, wherein the sensor arrangement includes a level sensor arrangement for measuring a level of substance in the vessel.

9. The appliance of claim 8, wherein the level sensor arrangement includes a plurality of low voltage probes distributed along a height of the vessel, each probe being configured to provide an output signal when immersed in substance.

10. The appliance of claim 6, wherein the sensor arrangement includes a tilt sensor for measuring a tilt of the vessel with respect to a reference plane.

11. An appliance including:
a vessel for containing substance, the vessel including a sensor arrangement for measuring a tilt of the vessel with respect to a reference plane,
a control unit that is in electrical communication with the sensor arrangement, the vessel control unit being configured to determine an amount of substance in the vessel based on measurements from the sensor arrangement when the vessel is tilted; and
a display unit that is in communication with the control unit, the control unit being configured to display the amount of substance in the vessel on the display unit.

12. The appliance of claim 11, further including a level sensor arrangement for measuring a level of substance in the vessel and a tilt sensor for measuring a tilt angle of the vessel with respect to the reference plane.

13. The appliance of claim 12, wherein the control unit is configured to determine if there is contamination in the vessel based on an output signal from the level sensor arrangement.

14. The appliance of claim 11, wherein the vessel is a water vessel containing a heating element for heating liquid in the vessel, the heating element being operable by the control unit depending on the amount of liquid in the vessel.

15. An appliance including:
a vessel for containing liquid to be heated, the vessel having:
a sensor arrangement for measuring an amount of substance in the vessel, and
a heating element for heating the liquid in the vessel, the heating element being operable to provide an adjustable amount of heating based on the amount of substance in the vessel.

16. The appliance of claim 15, wherein the vessel includes a temperature sensor mounted to a side wall portion of the vessel.

17. The appliance of claim 15, wherein the vessel includes a feedback actuator that provides a feedback signal depending on a substance level in the vessel, the feedback actuator being powered by the electrical energy storage component.

18. The appliance of claim 17, wherein the feedback actuator is configured to provide at least one of an audio output, a tactile output, and a visual output.

19. An appliance control unit for determining an amount of substance in an appliance when the appliance is at a tilt, the appliance including a vessel for containing substance and a sensor arrangement with a plurality of sensors distributed along a height of the vessel, the control unit being configured to:
determine an upper amount of substance in the vessel in an upper region, the upper region being a region in which a width dimension of the substance volume in the upper region at different height levels of the substance level in the upper region is less than a width of the vessel at those corresponding height levels; and
determine a lower amount of substance in the vessel in a lower region, the lower region being a region in which the width dimension of the substance volume in the lower region at different height levels of the level in the lower region is equal to a width of the vessel at those corresponding height levels,
wherein the amount of substance in the vessel is a summation of the upper amount of substance and the lower amount of substance.

20. The appliance control unit of claim 19, wherein the sensor arrangement includes a tilt sensor for measuring a tilt angle of the vessel with respect to a reference plane, the control unit being configured to determine the upper amount of substance based on the tilt angle.
